(19) United States
(12) Patent Application Publication
(10) Pub. No.: US 2025/0129923 A1
(43) Pub. Date: Apr. 24, 2025

(54) LAMP CELL BOX

(71) Applicant: HANGZHOU JINYIJIA E-COMMERCE CO., LTD., Hangzhou (CN)

(72) Inventor: Xudong ZHOU, Hangzhou (CN)

(21) Appl. No.: 18/666,392

(22) Filed: May 16, 2024

(30) Foreign Application Priority Data
Oct. 19, 2023 (CN) 202322814940.1

(51) Int. Cl. F21V 23/04; F21L 4/02; F21V 15/01; F21Y 103/10; F21Y 115/10

(52) U.S. Cl. CPC F21V 23/023; H02G 3/08; F21V 23/0414; F21V 23/0435; F21Y 2103/10; F21Y 2115/10

(57) ABSTRACT

A lamp cell box includes a switch, a least one button cell, a metal elastic sheet and a box holder. The switch includes a body, a button and a contact terminal. The metal elastic sheet includes a first elastic contact part. The box holder includes a cell trough, a switch trough, an elastic sheet trough, a first connection port and a second connection port, where the button cell is disposed in the cell trough, a portion of the metal elastic sheet is disposed in the elastic sheet trough, the body is disposed in the switch trough, the contact terminal penetrates through the first connection port and is in electrical contact with the negative electrode of the button cell, and the first elastic contact part penetrates through the second connection port and is in electrical contact with the positive electrode of the button cell.

### CROSS-REFERENCE TO RELATED APPLICATIONS

This application claims priority to Chinese Patent Application No. 202322814940.1 filed on Oct. 19, 2023, the entire contents of which are incorporated herein by reference.

### BACKGROUND OF THE INVENTION

### Field of the Invention

The present application relates to a cell box, and in particular to a lamp cell box.

### Description of the Related Art

For the convenience of outdoor use, existing light-emitting diode (LED) lamps are often equipped with cell boxes to facilitate the layout in outdoor scenes, thus providing better decorative effects. However, an existing cell box has a complex structure, which leads to complicated assembly, poor connection stability and high cost.

### BRIEF SUMMARY OF THE INVENTION

In order to overcome at least one of deficiencies in the prior art, the present application provides a lamp cell box, which simplifies the assembly operation, improves the connection stability and lowers the manufacturing cost.

In order to achieve the above purpose, the present application provides a lamp cell box, including a switch, at least one button cell, a metal elastic sheet and a box holder, where the switch includes a body, a button and a contact terminal, one end of the contact terminal is disposed at the body, and the button is movable relative to the body so as to control the on and off of the switch. One end face of the button cell is a negative electrode, and the other end face and a side surface of the button cell are a positive electrode. The metal elastic sheet includes a first elastic contact part. The box holder includes a cell trough, a switch trough, an elastic sheet trough, a first connection port and a second connection port, where the button cell is disposed in the cell trough, a portion of the metal elastic sheet is disposed in the elastic sheet trough, the body is disposed in the switch trough, the first connection port is communicated with the cell trough and the switch trough, the contact terminal penetrates through the first connection port and is in electrical contact with the negative electrode, located at the end face, of the button cell, the second connection port is communicated with the cell trough and the elastic sheet trough, and the first elastic contact part penetrates through the second connection port and is in electrical contact with the positive electrode, located at the side surface, of the button cell.

Optionally, the cell trough has a first fixing wall, a second fixing wall and a first supporting wall, the first fixing wall, the second fixing wall and the first supporting wall respectively surround peripheries of the button cell, the first connection port is located between the first fixing wall and the second fixing wall, and the second connection port is located between the first fixing wall and the first supporting wall.

Optionally, the cell trough further has a first bottom wall, and one end of the contact terminal is located between the first bottom wall and the negative electrode, located at the end face, of the button cell.

Optionally, the elastic sheet trough has a second supporting wall, and a portion of the metal elastic sheet is located between the first fixing wall and the second supporting wall.

Optionally, the metal elastic sheet includes a first positioning section and a second positioning section which are connected with each other, a cross section of the first positioning section and the second positioning section is L-shaped, the elastic sheet trough further includes a third fixing wall and a third supporting wall, the second supporting wall is connected to the third supporting wall, a cross section of the second supporting wall and the third supporting wall is L-shaped, the first positioning section is located between the first fixing wall and the second supporting wall, and the second positioning section is located between the third fixing wall and the third supporting wall.

Optionally, the switch trough has a fourth fixing wall, a fifth fixing wall and a fourth supporting wall, and the fourth fixing wall, the fifth fixing wall and the fourth supporting wall surround an outer side of the body.

Optionally, the lamp cell box further includes a sliding cove, the cell trough, the switch trough, the elastic sheet trough, the first connection port and the second connection port are covered with the sliding cover, and the sliding cover is detachably disposed on the box holder.

Optionally, the sliding cover includes a track groove and an elastic buckle, the box holder includes a guide rail part and a clamping groove, the guide rail part is slidably disposed in the track groove, and the elastic buckle is clamped in the clamping groove.

Optionally, the sliding cover includes a first plug and a second socket, the box holder includes a first socket and a second plug, the first plug is inserted into the first socket and the second plug is inserted into the second socket.

Optionally, at least two button cells are provided, and the at least two button cells are stacked in the cell trough in series.

Optionally, the switch is a toggle switch or a pressing switch.

Optionally, the lamp cell box further includes a wireless remote control chip disposed in the switch trough.

In the existing lamp cell box, besides the contact terminals of the switch are copper sheets, at least two copper sheets are also provided to be in electrical contact with the positive electrode and the negative electrode of the button cells located at two end faces respectively. However, in the lamp cell box provided by this application, in addition to the contact terminal of the switch, only one copper sheet is needed to be connected with the positive electrode, located at the side surface, of the button cell. In terms of manufacturing materials, one copper sheet is directly reduced, which greatly lowers the manufacturing cost. Moreover, the welding of copper sheets needs to be carried out manually, so that the reduction of the copper sheets can effectively reduce process steps and lower the labor cost, ultimately lowering the production cost, and meanwhile greatly improving the production efficiency. In addition, a conventional lamp cell box needs at least four screws to fix a cover and a base, and fix the copper sheet and the base. However, according to the cell box of the present application, different components are fixed by the division of different troughs, thus avoiding the use of screws and lowering the manufacturing cost.

In addition, the two button cells in the existing cell box are horizontally laid side by side in the cell box, so that the cell box has a large lateral volume and occupies more space, and more materials are needed for production and manufacturing. The two cells laid side by side need more copper sheets for electrical connection, which greatly increases the production and manufacturing costs. However, the two button cells in this embodiment are stacked, which not only reduces the transverse volume of the cell box, but also avoids the use of more copper sheets. Only one copper sheet needs to be in contact with the positive electrode, located on the side surface, of one of the button cells.

### BRIEF DESCRIPTION OF THE DRAWINGS

FIG. 1 is a perspective view of a lamp cell box provided by a first embodiment of the present application;

FIG. 2 is another perspective view of the lamp cell box provided by the first embodiment of the present application;

FIG. 3 is a schematic sectional view of the lamp cell box provided by the first embodiment of the present application;

FIG. 4 is a structural schematic diagram of the lamp cell box provided by the first embodiment of the present application after a sliding cover is dismounted;

FIG. 5 is a structural schematic diagram of a box holder of the lamp cell box provided by the first embodiment of the present application;

FIG. 6 is a structural schematic diagram of a switch of the lamp cell box provided by the first embodiment of the present application;

FIG. 7 is a structural schematic diagram of a metal elastic sheet of the lamp cell box provided by the first embodiment of the present application;

FIG. 8 is a structural schematic diagram of the sliding cover of the lamp cell box provided by the first embodiment of the present application;

FIG. 9 is a structural schematic diagram of button cells of a lamp cell box provided by the first embodiment of the present application;

FIG. 10 is a perspective view of a lamp cell box provided by a second embodiment of the present application;

FIG. 11 is another perspective view of the lamp cell box provided by the second embodiment of the present application;

FIG. 12 is a schematic sectional view of the lamp cell box provided by the second embodiment of the present application;

FIG. 13 is a structural schematic diagram of the lamp cell box provided by the second embodiment of the present application after a sliding cover is dismounted;

FIG. 14 is a structural schematic diagram of a box holder of the lamp cell box provided by the second embodiment of the present application;

FIG. 15 is a perspective view of the sliding cover of the lamp cell box provided by the second embodiment of the present application; and

FIG. 16 is another perspective view of the sliding cover of the lamp cell box provided by the second embodiment of the present application.

### DETAILED DESCRIPTION OF THE INVENTION

In order to facilitate the understanding of those skilled in the art, the present application will be further described with the attached drawings and specific embodiments.

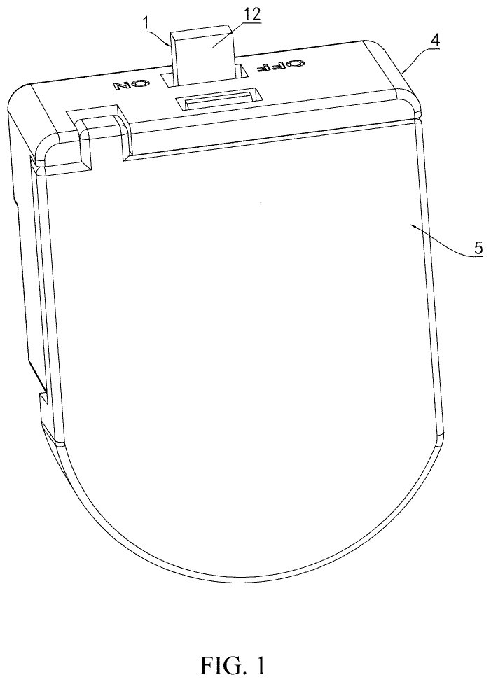

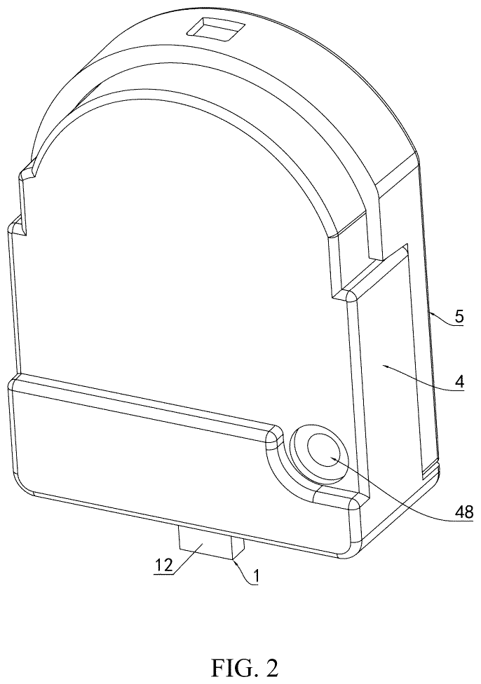

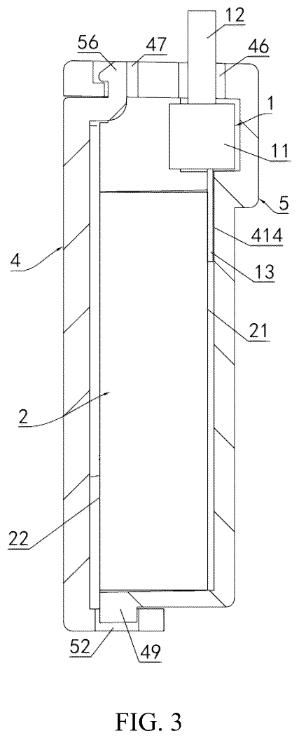

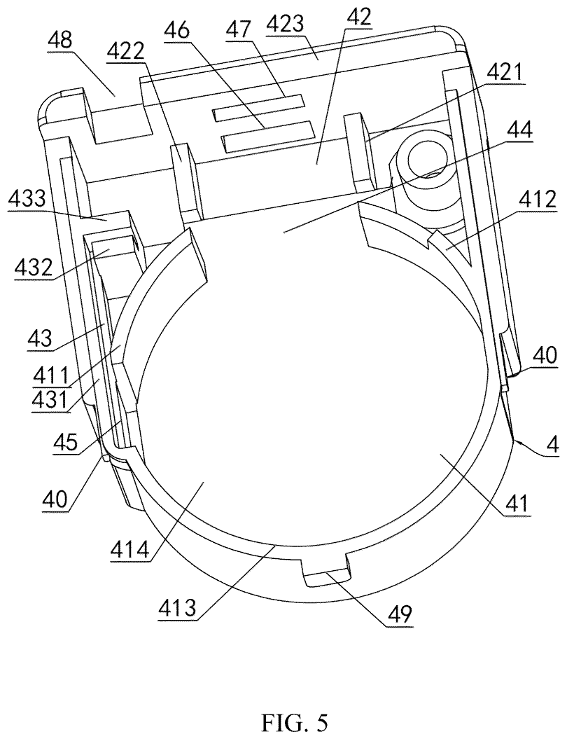

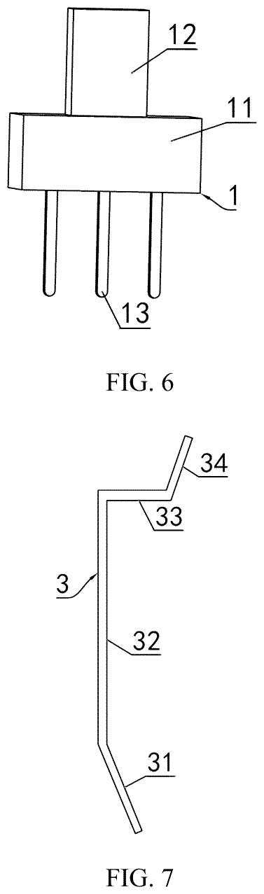

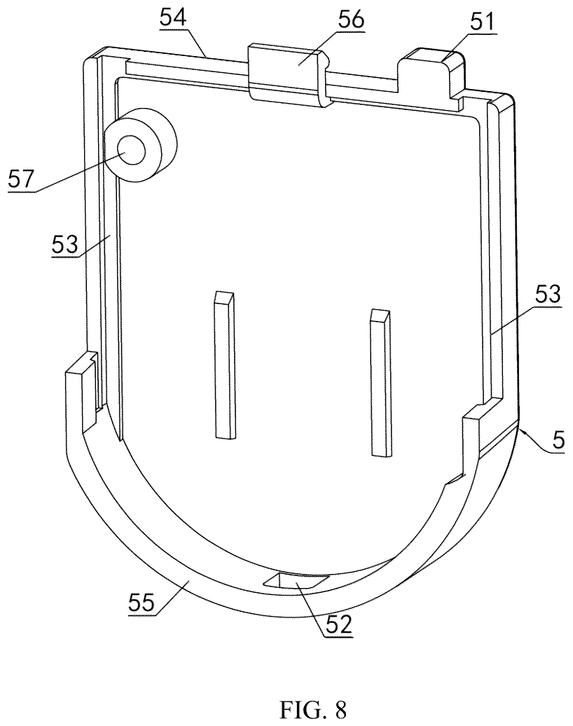

As shown in FIGS. 1 to 9, the first embodiment of the present application provides a lamp cell box, which includes a switch 1, a button cell 2, a metal elastic sheet 3, a box holder 4 and a sliding cover 5.

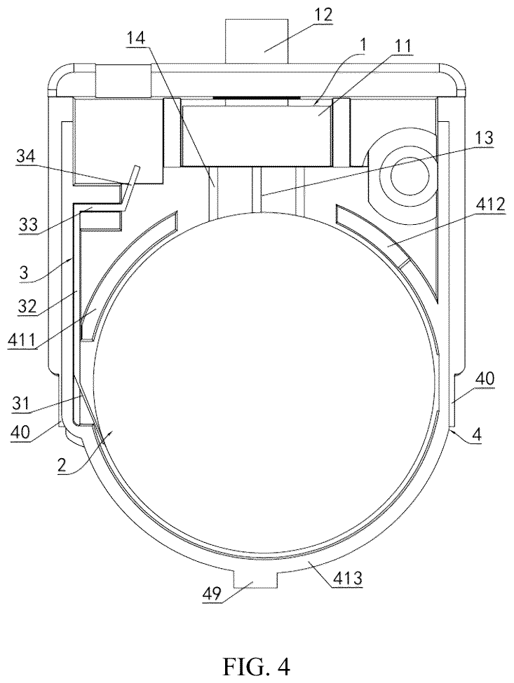

The switch 1 is a switching device for controlling the on-off of the button cell 2. The switch 1 includes a body 11, a button 12 and a contact terminal 13 and an overall structure of the body 11 is square. However, the shape of the body 11 is not specifically limited in the present application. One end of the contact terminal 13 is disposed at the body 11, and the button 12 is movable relative to the body 11 so as to control the on and off of the switch 1. Specifically, the switch 1 of this embodiment is a toggle switch, and the button 12 can be toggled left and right to change an angle with respect to the body 11 as shown in FIG. 4, so as to be switched between ON and OFF states. In this embodiment, the contact terminal 13 includes three PINs, and the three PINs can be electrically connected or disconnected by toggling the button 12.

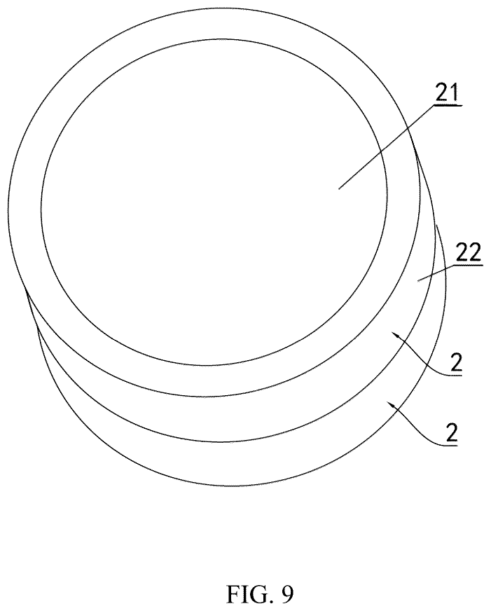

One end face of the button cell 2 is a negative electrode 21, and the other end face and side surface of the button cell are a positive electrode 22. As shown in FIG. 9, the upper end face of the button cell 2 is a negative electrode, and the lower end face and side surface of the button cell are a positive electrode 22. In this embodiment, the lamp cell box includes at least two button cell 2. The at least two button cells 2 are stacked in series in a cell trough 41. Specifically, the negative electrode 21 of the button cell 2 located below is in close contact with the positive electrode 22 of the lower end face of the button cell 2 located above. When the button cells 2 are put into the cell trough 41, the positive electrodes 22 of the button cells face the sliding cover 5, and the negative electrodes 21 of the button cells face a bottom of the box holder 4. At this time, the metal elastic sheet 3 is in electrical contact with the positive electrode 22 on the side surface of the button cell 2 located above. The negative electrode 21 of the button cell 2 located below electrically contacts the contact terminal 13 of the switch 1. By stacking at least two button cells, a structure is more compact, a transverse volume size of the lamp cell box can be greatly reduced, less materials are needed for manufacturing the cell box, and the manufacturing cost is lowered.

The metal elastic sheet 3 can be in electrical contact with the positive electrode 22, located at the side surface, of the button cell, and one end of the contact terminal 13 is in electrical contact with the negative electrode 21, located at the end face, of the button cell. In actual use, the metal elastic sheet 3 and one pin, located on a leftmost side in FIG. 4, of the PINs of the contact terminal 13 of the switch 1 are also electrically connected to an LED lamp string (not shown), the button cells 2, the metal elastic sheet 3, the switch 1 and the LED lamp string form an LED control circuit, and the LED lamp string can be controlled by toggling the button 12.

The metal elastic sheet 3 includes a first elastic contact part 31, a positioning part and a second elastic contact part 34. The first elastic contact part 31, the positioning part and the second elastic contact part 34 are manufactured by a bending process on metal sheets, with the metal sheets necessarily having good elasticity and conductivity. The first elastic contact part 31 is in electrical contact with the positive electrode 22 of the button cell 2, and the second elastic contact part 34 is used to be electrically connected to the LED lamp string. Specifically, in order to improve the connection stability of the positioning part on the box holder 4, the positioning part includes a first positioning section 32 and a second positioning section 33, the first positioning section 32 and the second positioning section 33 may also be made by bending metal sheets, the first elastic contact part 31, the first positioning section 32, the second positioning section 33 and the second elastic contact part 34 are connected together in sequence, and a cross section of the first positioning section 32 and the second positioning section 33 is L-shaped. In this embodiment, the metal elastic sheet 3 is a copper sheet.

The box holder 4 includes a cell trough 41, a switch trough 42, an elastic sheet trough 43, a first connection port 44 and a second connection port 45, the button cells 2 are disposed in the cell trough 41, the body 11 is disposed in the switch trough 42, and the positioning part of the metal elastic sheet 3 is disposed in the elastic sheet trough 43. The first connection port 44 is communicated with the cell trough 41 and the switch trough 42, and the contact terminal 13 penetrates through the first connection port 44 and is in electrical contact with the negative electrode 21, located at the lower end face, of the button cell 2. The second connection port 45 is communicated with the cell trough 41 and the elastic sheet trough 43, the first elastic contact part 31 penetrates through the second connection port 45 and is in electrical contact with the positive electrode 22, located on the side surface, of the button cell 2.

In this embodiment, the box holder 4 further includes a switch hole 46, the switch hole 46 is communicated with the switch trough 42, the button 12 penetrates through the switch hole 46, and the button 12 extends out of the box holder 4 through the switch hole 46, so that a user can conveniently toggle the button 12 outside the box holder 4.

The cell trough 41 has a first fixing wall 411 and a second fixing wall 412. The first fixing wall 411 and the second fixing wall 412 have arc-shaped cross sections, so as to fully fit peripheries of the button cells 2. In this embodiment, the first fixing wall 411 and the second fixing wall 412 can be made of inelastic materials, and the button cells 2 can be fixed in the cell trough 41 through the cooperation between the sliding cover 5 and the box holder 4. However, the present application does not impose any restrictions on this. In another embodiment, the first fixing wall 411 and the second fixing wall 412 can be thin-walled structures which can be elastically deformed, and the first fixing wall 411 and the second fixing wall 412 are located at peripheries of the button cells 2, so that the button cells 2 can be mounted in and dismounted from the cell trough 41 by expanding the first fixing wall 411 and the second fixing wall 412.

The cell trough 41 further has a first supporting wall 413. A cross section of the first supporting wall 413 is also arc-shaped, so as to fully fit outer side walls of the button cells 2. The first fixing wall 411, the second fixing wall 412 and the first supporting wall 413 surround the peripheries of the button cells 2. In this way, a position of the button cell 2 in the box holder 4 is limited, so as to improve the connection stability between the button cell 2 and the contact terminal 13; the first connection port 44 is located between the first fixing wall 411 and the second fixing wall 412, and the second connection port 45 is located between the first fixing wall 411 and the first supporting wall 413.

In this embodiment, the cell trough 41 further has a first bottom wall 414, and the contact terminal 13 is located between the first bottom wall 414 and the negative electrode 21, located at the end face, of the button cell, so as to improve the contact performance between the contact terminal 13 and the negative electrode 21.

The switch trough 42 has a fourth fixing wall 421 and a fifth fixing wall 422, and the fourth fixing wall 421 and the fifth fixing wall 422 are located at two sides of the body 11. In this embodiment, the fourth fixing wall 421 and the fifth fixing wall 422 are made of inelastic materials. However, in other embodiments, the fourth fixing wall 421 and the fifth fixing wall 422 may also be thin-walled structures that can be elastically deformed, so that the body 11 can be mounted in and dismounted from the switch trough 42 by expanding the fourth fixing wall 421 and the fifth fixing wall 422.

A fourth supporting wall 423 is further disposed at an inner wall of the switch trough 42. The fourth fixing wall 421, the fifth fixing wall 422 and the fourth supporting wall 423 surround an outer side of the body 11. A position of the body 11 in the switch trough 42 is limited in this way, to improve the connection stability between the switch 1 and the button cells 2. The fourth fixing wall 421, the fifth fixing wall 422 and the fourth supporting wall 423 are all flat, so as to fully fit an outer side wall of the body 11. However, the present application does not make any restrictions on this, and in other embodiments, if the body of the switch has other shapes, the fourth fixing wall 421 and the fifth fixing wall 422 may have corresponding other shapes. The switch hole 46 is located in the fourth supporting wall 423, and the button 12 protrudes outward through the switch hole 46 in the fourth supporting wall 423.

In this embodiment, in order to reduce the volume as much as possible for the reduction of the use of materials, the elastic sheet trough 43 and the cell trough 41 share the first fixing wall 411. The elastic sheet trough further has a second supporting wall 431, and the first positioning section 32 is located between the first fixing wall 411 and the second supporting wall 431. The elastic sheet trough further has a third fixing wall 432 and a third supporting wall 433, the second positioning section 33 is located between the third fixing wall 432 and the third supporting wall 433, the second supporting wall 431 is connected to the third supporting wall 433, a cross section of the second supporting wall 431 and the third supporting wall 433 is L-shaped, and the second supporting wall 431 and the third supporting wall 433 can fully fit the first positioning section 32 and the second positioning section 33.

The sliding cover 5 covers the cell trough 41, the switch trough 42, the elastic sheet trough 43, the first connection port 44 and the second connection port 45, and the sliding cover 5 and the box holder 4 has a sealing protection effect on the switch 1, the button cell 2 and the metal elastic sheet 3.

Considering the subsequent replacement of the button cells 2, the sliding cover 5 and the box holder 4 are detachably disposed together. The sliding cover 5 includes a first plug 51, the box holder 4 includes a first socket 48, and the first plug 51 is inserted into the first socket 48. The sliding cover 5 includes a fifth supporting wall 54, the first plug 51 is located on the fifth supporting wall 54, the first socket 48 is located in the fourth supporting wall 423, the fifth supporting wall 54 is also flat, and the fifth supporting wall 54 fully fits the fourth supporting wall 423. The sliding cover 5 further includes a second socket 52, the box holder 4 further includes a second plug 49, and the second plug 49 is inserted into the second socket 52. Through this arrangement, the sliding cover 5 and the box holder 4 can be fixed without additional fixing elements (such as screws). A number of mounting accessories is reduced, and a mounting process is simplified.

In actual use, the LED lamp string is electrically connected with wires. In this embodiment, the first socket 48 is also used for wires of the LED lamp string to pass through, and two wires of the LED lamp string pass through the first socket 48 and enter an interior of the lamp cell box to be electrically connected the second elastic contact part 34 of the metal elastic sheet 3 and the contact terminal 13 of the switch 1 respectively. However, the present application does not impose restrictions on this. In other embodiments, the box holder 4 may further include specially disposed threading holes through which the wires pass. The two wires of the LED lamp string can be in electrical contact with the second elastic contact part 34 and the PINs of the contact terminal 13 after passing through the threading holes. The threading holes may be located in the fourth supporting wall 423.

The sliding cover 5 includes a sixth supporting wall 55, the second socket 52 is located in the sixth supporting wall 55, the second plug 49 is located on the first supporting wall 413, a cross section of the sixth supporting wall 55 is arc-shaped, and the sixth supporting wall 55 fully fits the first supporting wall 413. The sliding cover 5 includes an elastic buckle 56, the box holder 4 includes a clamping groove 47, the elastic buckle 56 is clamped in the clamping groove 47, the elastic buckle 56 is located on the fifth supporting wall 54, and the clamping groove 47 is located on the fourth supporting wall 423.

The sliding cover 5 includes a track groove 53, the box holder 4 includes a guide rail part 40, the guide rail part 40 is slidably disposed in the track groove 53, a sliding direction of the guide rail part 40 in the track groove 53, unplugging and plugging directions of the first plug 51 in the first socket 48 are consistent with unplugging and plugging directions of the second plug 49 in the second socket 52, so that the sliding cover 5 can be quickly dismounted from and mounted on the box holder 4.

In this embodiment, the sliding cover 5 may include a first connecting hole 57, the box holder 4 may include a second connecting hole 48, the second connecting hole 48 penetrates through the box holder 4, the first connecting hole 57 is directly opposite to the second connecting hole 48, the first connecting hole 57 and the second connecting hole 48 are used for the mounting of screws, the first connecting hole 57 may be a threaded hole, and the screw is screwed in the first connecting hole. By fixing the sliding cover 5 and the box holder 4 with screws, infant and babies are prevented from taking out the cell by dismounting the sliding cover themselves, the difficulty of dismounting the body of the lamp cell box is increased and thus the safety for the infant and babies is improved. However, the present application does not impose restrictions on this. In other embodiments, the lamp cell box does not need to be fixed by screws, so there is no need to set up the connecting holes.

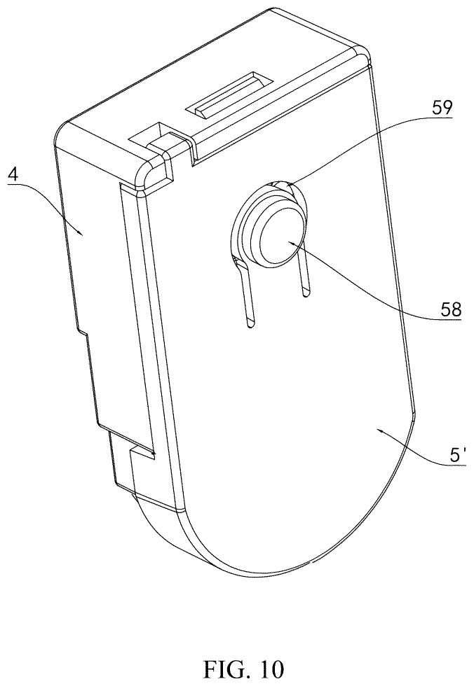

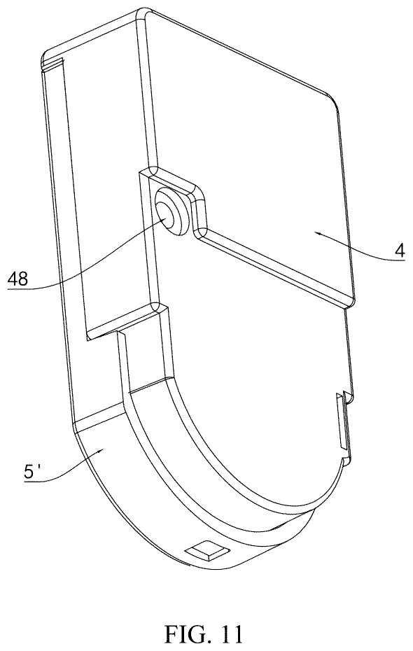

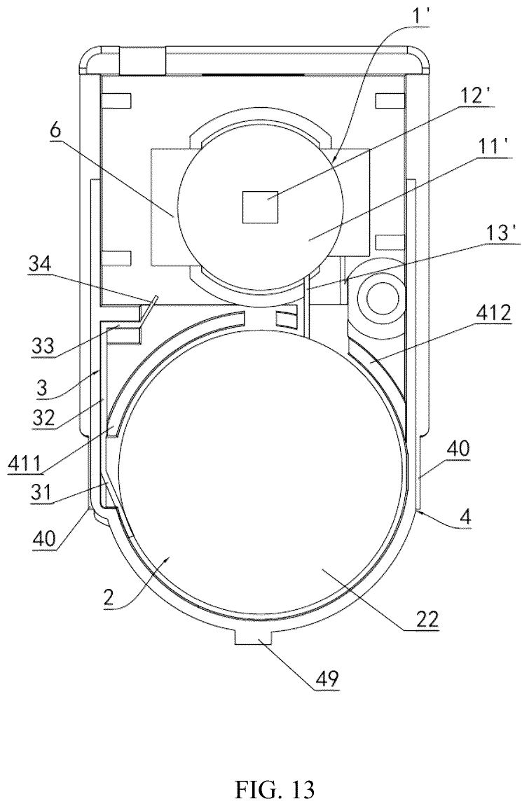

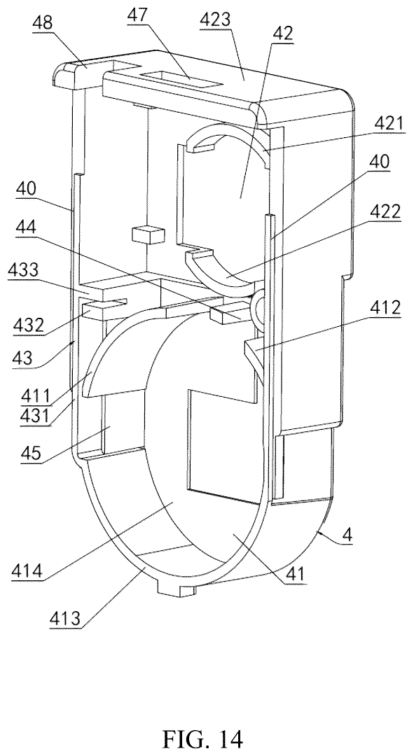

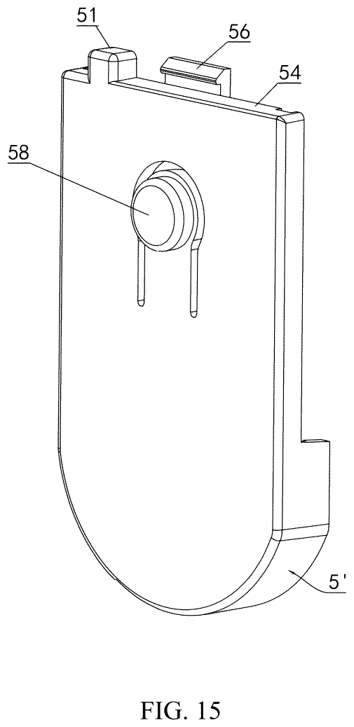

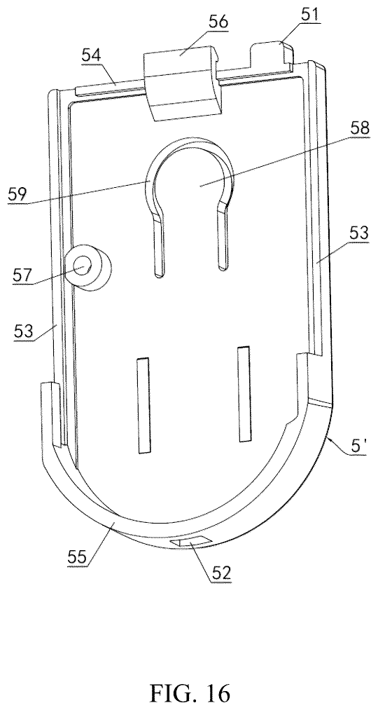

FIGS. 10-16 are schematic diagrams of the lamp cell box provided by the second embodiment of the present application. A main structure and functions of the lamp cell box provided by the second embodiment are the same as those of the lamp cell box provided by the first embodiment, and reference can be made to the first embodiment in connection with the related description of the drawings. The same structure and functions as those of the first embodiment will not be described again. The following only explains the differences.

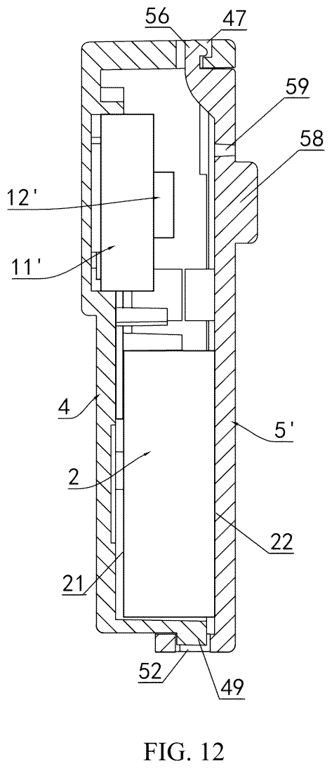

A switch 1′ of the second embodiment is a pressing switch. The pressing switch 1′ includes a body 11′, a button 12′ and a contact terminal 13′. One end of the contact terminal 13′ is disposed on the body 11′, and the button 12′ is movable relative to the body so as to control the on and off of the switch 1′. Specifically, a sliding cover 5′ may be provided with a gap 59, so that a portion of the sliding cover 5′ forms a push member 58 which can move relatively to the box holder 4. As shown in FIG. 12, under the action of external force, the push member 58 can move to the left, so as to be in contact with the button 12′, thereby turning on the switch 1′.

Since the body 11′ of the switch 1′ provided by the second embodiment is circular, the fourth fixing wall 421 and the fifth fixing wall 422 of the switch trough 42 are correspondingly arc-shaped. The present application does not pose any restrictions on the shapes of the body of the switch and the fourth fixing wall and the fifth fixing wall of the switch trough.

In the second embodiment, the lamp cell box may further include a wireless remote control chip 6 disposed in the switch trough 42. With the arrangement of the wireless remote control chip 6, the on and off of the switch 1′ can be remotely controlled by the remote controller. Similarly, the lamp cell box in the first embodiment may also be provided with a wireless remote control chip.

To sum up, the lamp cell box provided by the present application simplifies the assembly operation, improves the connection stability and greatly lowers the production and manufacturing costs.

The above embodiments are only preferred embodiments of the present application, and the protection scope of the present application is not limited thereby, so: equivalent changes made according to the structure, shape and principle of the present application shall be covered by the protection scope of the present application.

1. A lamp cell box, comprising:
a switch comprising a body, a button and a contact terminal, wherein one end of the contact terminal is disposed at the body, and the button is movable relative to the body so as to control on and off of the switch;
at least one button cell, wherein one end face of the at least one button cell is a negative electrode, and another end face and a side surface of the at least one button cell are a positive electrode;
a metal elastic sheet comprising a first elastic contact part; and
a box holder comprising a cell trough, a switch trough, an elastic sheet trough, a first connection port and a second connection port, wherein the at least one button cell is disposed in the cell trough, a portion of the metal elastic sheet is disposed in the elastic sheet trough, the body is disposed in the switch trough, the first connection port is communicated with the cell trough and the switch trough, the contact terminal penetrates through the first connection port and is in electrical contact with the negative electrode, located at the end face, of the at least one button cell, the second connection port is communicated with the cell trough and the elastic sheet trough, and the first elastic contact part penetrates through the second connection port and is in electrical contact with the positive electrode, located at the side surface, of the at least one button cell.

2. The lamp cell box according to claim 1, wherein the cell trough has a first fixing wall, a second fixing wall and a first supporting wall, the first fixing wall, the second fixing wall and the first supporting wall respectively surround peripheries of the at least one button cell, the first connection port is located between the first fixing wall and the second fixing wall, and the second connection port is located between the first fixing wall and the first supporting wall.

3. The lamp cell box according to claim 2, wherein the cell trough further has a first bottom wall, and one end of the contact terminal is located between the first bottom wall and the negative electrode, located at the end face, of the at least one button cell.

4. The lamp cell box according to claim 2, wherein the elastic sheet trough has a second supporting wall, and the portion of the metal elastic sheet is located between the first fixing wall and the second supporting wall.

5. The lamp cell box according to claim 4, wherein the metal elastic sheet comprises a first positioning section and a second positioning section which are connected with each other, a cross section of the first positioning section and the second positioning section is L-shaped, the elastic sheet trough further comprises a third fixing wall and a third supporting wall, the second supporting wall is connected to the third supporting wall, a cross section of the second supporting wall and the third supporting wall is L-shaped, the first positioning section is located between the first fixing wall and the second supporting wall, and the second positioning section is located between the third fixing wall and the third supporting wall.

6. The lamp cell box according to claim 1, wherein the switch trough has a fourth fixing wall, a fifth fixing wall and a fourth supporting wall, and the fourth fixing wall, the fifth fixing wall and the fourth supporting wall surround an outer side of the body.

7. The lamp cell box according to claim 1, further comprising a sliding cover, wherein the cell trough, the switch trough, the elastic sheet trough, the first connection port and the second connection port are covered with the sliding cover, and the sliding cover is detachably disposed on the box holder.

8. The lamp cell box according to claim 7, wherein the sliding cover comprises a track groove and an elastic buckle, the box holder comprises a guide rail part and a clamping groove, the guide rail part is slidably disposed in the track groove, and the elastic buckle is clamped in the clamping.

9. The lamp cell box according to claim 7, wherein the sliding cover comprises a first plug and a second socket, the box holder comprises a first socket and a second plug, the first plug is inserted into the first socket, and the second plug is inserted into the second socket.

10. The lamp cell box according to claim 1, wherein at least two button cells are provided, and the at least two button cells are stacked in the cell trough in series.

11. The lamp cell box according to claim 1, wherein the switch is a toggle switch or a push pressing switch.

12. The lamp cell box according to claim 1, further comprising a wireless remote control chip disposed in the switch trough.
